(19) United States
(12) Patent Application Publication
(10) Pub. No.: US 2023/0297815 A1
(43) Pub. Date: Sep. 21, 2023

(54) SPARSE BINARY REPRESENTATION FOR SELF SUPERVISED INFORMATION EXTRACTION

(71) Applicant: AUTOBRAINS TECHNOLOGIES LTD, Tel Aviv-Yafo (IL)

(72) Inventors: Nitzan DAHAN, Tel Aviv (IL); Lior BLECH, TEL AVIV (IL); Igal Raichelgauz, TEL AVIV (IL)

(73) Assignee: AUTOBRAINS TECHNOLOGIES LTD, Tel Aviv-Yafo (IL)

(21) Appl. No.: 18/184,616

(22) Filed: Mar. 15, 2023

Related U.S. Application Data
(60) Provisional application No. 63/269,449, filed on Mar. 16, 2022.

(51) Int. Cl. G06N 3/0455; G06N 3/0985

(52) U.S. Cl. CPC G06N 3/0455; G06N 3/0985

(57) ABSTRACT

A method for generating a sparse binary representation (SBR) of neural network intermediate features (NNIFs) of a neural network (NN). The method includes (i) feeding the neural network by input information; (ii) neural network processing the input information to provide, at least, the NNIFs; (iii) SBR processing, by a SBR module, the NNIFs, to provide the SBR representation of the NNIFs; and (iv) outputting the SBR representation. The SBR module has undergone a training process that used a loss function that takes into account a sparsity of training process SBR representations.

### BACKGROUND OF THE INVENTION

Neural networks are a subset of machine learning algorithms, inspired by the structure of the human brain. The attracting feature of neural networks is their ability to represent a vast space of functions while being relatively simple to implement. A downside of neural networks is their typically black box nature, which leads to difficulties in developing interpretable and robust neural networks. One difference between the workings of neural networks and the brain is that neural network activations are relatively dense, whereas the brain activates very sparsely.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a method;

FIG. 3 illustrates an example of a neural network and of a SBR module;

FIG. 4 illustrates an example of a neural network, a SBR module and additional modules and/or units;

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Sparse binary readouts is a building block inspired by the brain which increases the sparseness of the neural network by connecting to an existing network and converting the dense activations to a sparse representation. The sparse representations enable disentangling the original neural network features into more interpretable and robust features.

The new sparse representation is better suited to apply either further neural network building blocks or classical algorithms, which improves the base network performance and robustness as well as improving interpretability.

In addition due to its self-supervised nature, it enables applications such as
a. Providing context information absent in typical ground truth scenarios.
b. Enabling changing or adding labels post hoc.
c. Adding new functionality absent in the base network.

Using SBR tool (Sparse Binary Readout Technology), through which it is possible to exhaust the information and make decisions in a smarter way and close to human judgment. The current solution provides a highly effective solution that manages to extract, while using few resources (especially in comparison to using another dedicated NN), information of value that is embedded in the intermediate layers of the NN. Furthermore- the training process is highly efficient as is takes into account both sparsity and accuracy of reconstruction - and saves an extensive amount of training iterations - as well as providing a desired (and tunable) tradeoff between sparsity and accuracy of reconstructions.

The use of a tool is similar to the realization of information from the subconscious of the person to conscious.

The suggested solution takes a divide and conquer approach to machine learning. While other solutions approach applications one at a time and develop end to end solutions for each, the current solution involves extracting useful information from a network which has previously been trained on one task.

Other systems exist which have technical similarities in terms of either producing sparse intermediate representations or partially disentangling the feature space. However the suggested solution combines both of these features and puts the sparse representation in a central role rather than as a regularization tool.

The solution may involve using the large dimensions allows for more extensive detail on the data and also allows for the creation of new labels without training.

The combined NN and SBR may be flexibly connected to any kind of model or task.

The solution can connect to the model in several places and thus highlight the features that are relevant to the task over other features.

The solution may include (i) Sparse Binary Readout connects to a fixed neural network layer and extracts a useful sparse representation. (ii) SBR is free to adaptively connect to arbitrary layers and learn optimal information, taking advantage of correlations between features in different layers. (iii) Prune the features of the original neural network in order to improve robustness and leave out irrelevant information which causes errors. This is done by exploiting interrelationships between features in the sparse representation. (iv) Develop a set of sparse representations, each specializing in a specific subset of features to improve performance in that subspace. Consequently exploit interrelations in the domains to achieve performance better than “sum of components”. (IV) Develop a set of sparse representations, each specializing in a specific subset of features to improve performance in that subspace. Consequently exploit interrelations in the domains to achieve performance better than “sum of components”.

Step (i) may be fixed. Step (ii) may be exploratory. Step (iii) may be pro-active. Step (iv) may use multiple heads.

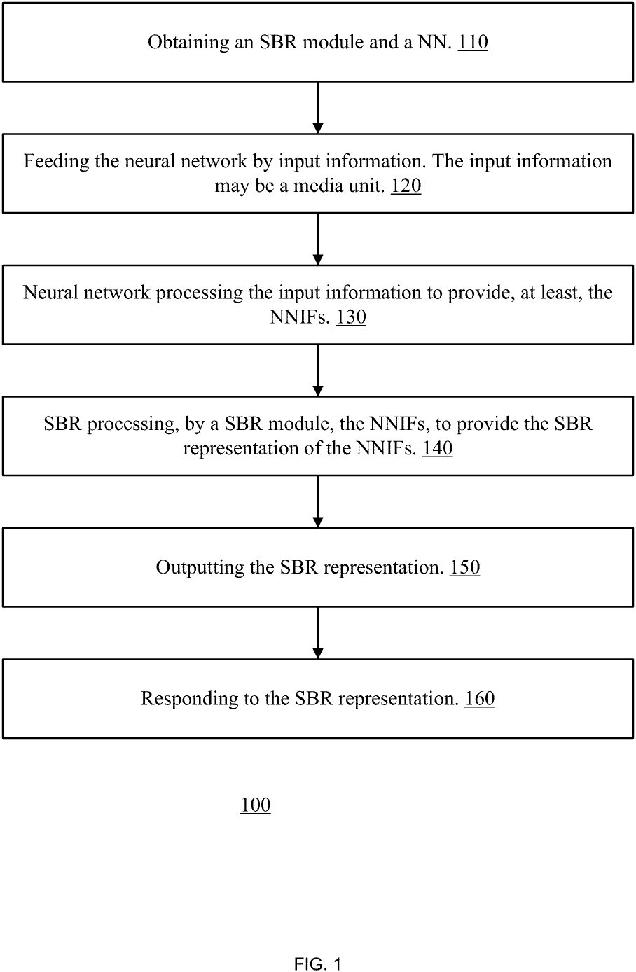

FIG. 1 illustrates an example of a method 100.

Method 100 is for generating a sparse binary representation (SBR) of neural network intermediate features (NNIFs) of a neural network (NN).

Method 100 may start by step 110 of obtaining an SBR module and a NN.

Step 110 may include training the SBR module by applying a training process or receiving a SBR module that was already trained by a training process.

The training process uses a loss function that takes into account a sparsity of training process SBR representations.

The loss function may also take into account an accuracy of a set reconstructed training process NNIFs - that was generated during a training process.

The NN may include multiple layers and the NNIFs used during inference may be selected in any manner. The NNIFs may be selected out of NNIFs candidates in any manner. For example - the selection of the NNIFs may be dictated before the training process. Yet for another example - the NNIFs may be determined and/or amended during the training process.

The selection of the NNIFs may be responsive to one or more objects of interest. The SBR representation should include information about the one or more objects of interest.

The selection may be based on knowledge about the outputs of one or more layers of the NN ̅- for example - assuming that the object of interest is a traffic light -then one or more NNIFs may be selected out of one or more first layers of the NN that provide information about the coarse shape of an object.

The sparsity of the training process SBR representation may be less significant than the accuracy of the set reconstructed training process NNIFs. For example - the sparsity may be less significant from the accuracy by a factor that ranges between two to ten.

The NNIFs may be outputted from one or more layers of the NN.

The NNIFs may be selected based on one or more objects of interest to be represented by the SBR representation of the NNIFs.

The SBR module may include an encoder that is followed by a thresholding unit. The training process may also use a decoder that follows the thresholding unit and may also include a loss function calculator and an encoder-decoder amending unit that is configured to amend the encoder and the decoder based on a value of the loss function.

Step 110 may be followed by step 120 of feeding the neural network by input information. The input information may be a media unit.

Step 120 may be followed by step 130 of neural network processing the input information to provide, at least, the NNIFs. Step 130 may also include providing NN outputs - for example providing output features from an output stage of the NN. If, for example, the NN includes multiple heads than the output stages of the multiple heads are regarded as the output stage of the NN.

Step 130 may be followed by step 140 of SBR processing, by a SBR module, the NNIFs, to provide the SBR representation of the NNIFs.

Step 140 may be followed by step 150 of outputting the SBR representation.

Step 150 may be followed by step 160 of responding to the SBR representation.

Step 160 may include performing an autonomous driving operation based on the SBR representation of the NNIFs.

Method 100 may be executed by a processor. The processor may be or may include one or more processing circuitries. The processing circuitry may be implemented as a central processing unit (CPU), and/or one or more other integrated circuits such as application-specific integrated circuits (ASICs), field programmable gate arrays (FPGAs), full-custom integrated circuits, a graphic processing unit (GPU), a neural network accelerator, etc., or a combination of such integrated circuits.

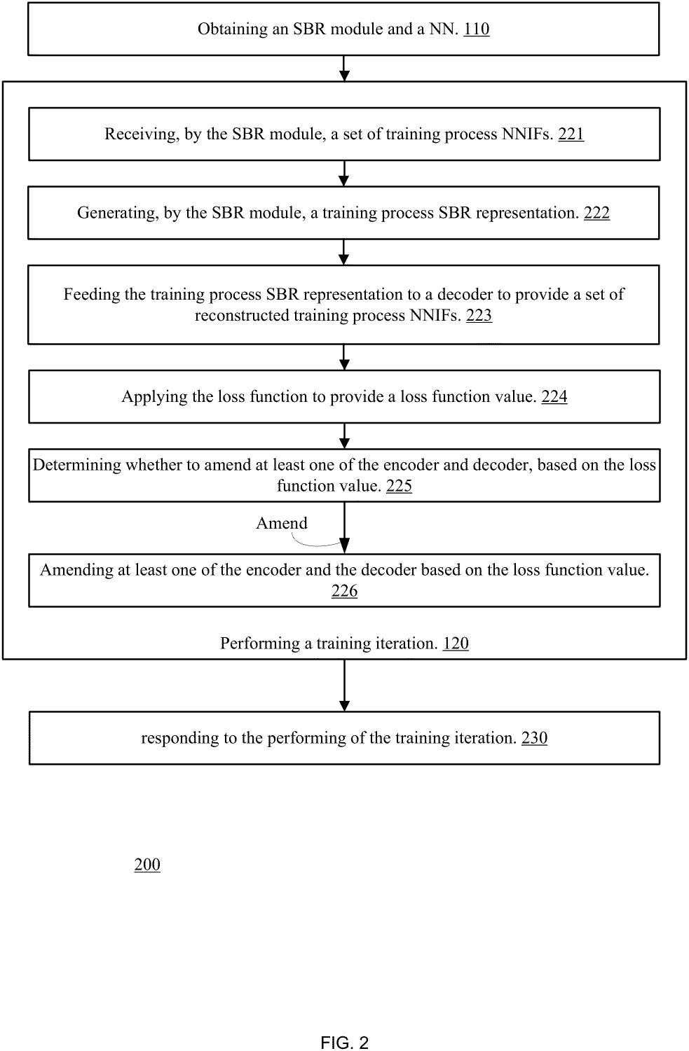

FIG. 2 illustrates an example of method 200 for training an SBR module.

Method 200 may start by step 210 of obtaining the SBR module and a neural network (NN).

Step 210 may be followed by step 220 of performing a training iteration.

Step 220 may include steps 221, 222, 223, 224, 225 and 226.
a. Step 221 may include receiving, by the SBR module, a set of training process NNIFs.
b. Step 222 may include generating, by the SBR module, a training process SBR representation. Step 222 may include calculating, by the encoder, a signature of the set of training process NNIFs.
c. Step 223 may include feeding the training process SBR representation to a decoder to provide a set of reconstructed training process NNIFs.
d. Step 224 may include applying the loss function to provide a loss function value. The loss function value is based on the sparsity of the training process SBR representation and on an accuracy of the set reconstructed training process NNIFs. The sparsity may be calculated in various manners - for example by applying a L1 regularizer. The accuracy may be calculated in various manners - for example by applying a mean square error calculation.
e. Step 225 may include determining whether to amend at least one of the encoder and decoder, based on the loss function value.
f. Step 226 may include amending at least one of the encoder and the decoder based on the loss function value - when it is determined (in step 225) to perform the amendment. An example of an amendment may include backpropagation.

Step 220 may be followed by step 230 of responding to the performing of the training iteration.

Step 230 may include at least one out of:
a. Performing another training iteration - for example using another set of training process NNIFs.
b. Determining whether to perform another training iteration - and when it is determined to perform another training iteration - performing the other training iteration.
c. Validating the SBR module and/or the neural network.
d. Evaluating an amount of irrelevant bits within the training process SBR representation.
e. Changing at least one hyper parameter.
f. Changing at least one hyper parameter and performing additional testing iterations when the amount of irrelevant bits exceeds a threshold.
g. Selecting outputs of one of more layers of the NN to provide the other set of training process NNIFs.

Hyper parameters are used to control the learning process. Examples of hyper parameters are provided below:
a. Batch size (number of samples to work through before updating an internal model parameters).
b. Learning rate range (controls the rate or speed at which the model learns. Specifically, it controls the amount of apportioned error that the weights of the model are updated with each time they are updated, such as at the end of each batch of training examples).
c. Learning rate scheduler (the learning rate may change the learning rate over time) such as step decay, cosine annealing, stochastic gradient decent (SGD), SGD with warm restart, super-convergence, adaptive schedulers, cyclic learning rate scheduler.
d. Used groups in the layers.

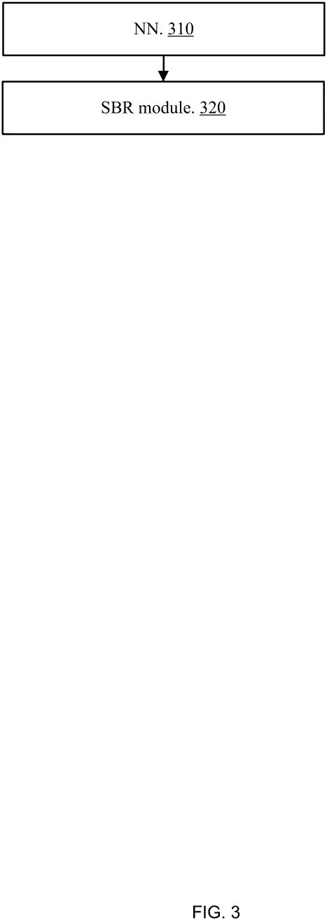

FIG. 3 illustrates an example of a NN 310 and of a SBR module 320. The SBR module 320 includes an encoder 322 and a thresholding unit 324.

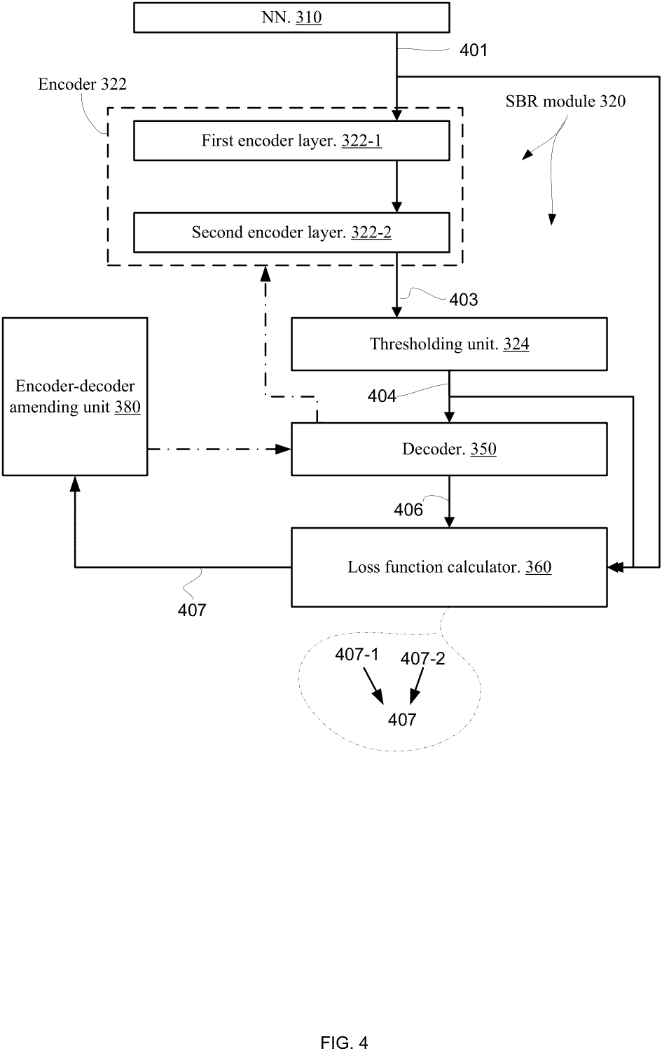

FIG. 4 illustrates an example of NN 310, SBR module 320, decoder 350, loss function calculator 360, a validation unit 370, and an encoder-decoder amending unit 380 that is configured to amend the encoder and the decoder based on a value of the loss function.

In FIG. 4:
a. The SBR module is fed by set of training process NNIFs 401.
b. The encoder 322 includes a first layer 322-1 and a second layer 322-2.
c. The second layer 322-2 outputs a signature 403 of the set of training process NNIFs 401.
d. The signature is not binary.
e. The thresholding unit 324 compares the elements of signature 403 to a threshold to provide a SBR representation 404 of the set of training process NNIFs 401.
f. The SBR representation 404 is fed to the decoder 350.
g. The decoder 350 calculates set of reconstructed training process NNIFs 406.
h. The loss function calculator 360 applies the loss function to provide a loss function value 407. The loss function value 407 may be based on the sparsity of the training process SBR representation (sparsity score 407-1) and on an accuracy of the set reconstructed training process NNIFs 406 (accuracy score 407-2) . The accuracy may be calculated by comparing the set of training process NNIFs 401 to the set reconstructed training process NNIFs 406. Any other distance or difference calculations may be executed.
i. The encoder-decoder amending unit 380 is illustrated as a back-propagating unit that may include a straight through estimator.
j. The validation unit 370 may validate the encoder and/or decoder and/or the training process SBR representation. One or more validation results may trigger a change in the encoder and/or decoder.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for generating a sparse binary representation (SBR) of neural network intermediate features (NNIFs) of a neural network (NN), the method comprises:
feeding the neural network by input information;
neural network processing the input information to provide, at least, the NNIFs;
SBR processing, by a SBR module, the NNIFs, to provide the SBR representation of the NNIFs; and
outputting the SBR representation;
wherein the SBR module has undergone a training process that used a loss function that takes into account a sparsity of training process SBR representations.

2. The method according to claim 1 wherein the SBR module comprises an encoder that is followed by a thresholding unit.

3. The method according to claim 2, comprising training the SBR module.

4. The method according to claim 3, wherein the training comprises performing multiple training iterations;
wherein a training iteration comprises:
receiving by the SBR module a set of training process NNIFs;
generating, by the SBR module, a training process SBR representation;
feeding the training process SBR representation to a decoder to provide
a set of reconstructed training process NNIFs;
applying the loss function to provide a loss function value; wherein the loss function value is based on the sparsity of the training process SBR representation and on an accuracy of the set reconstructed training process NNIFs.

5. The method according to claim 4 comprising amending the encoder and the decoder based on the loss function value.

6. The method according to claim 4 wherein the generating of the training process SBR representation comprises calculating, by the encoder, a signature of the set of training process NNIFs.

7. The method according to claim 4 comprising evaluating an amount of irrelevant bits within the training process SBR representation.

8. The method according to claim 7, comprising changing at least one hyper parameters and performing additional testing iterations when the amount of irrelevant bits exceeds a threshold.

9. The method according to claim 4 wherein the sparsity of the training process SBR representation is less significant than the accuracy of the set reconstructed training process NNIFs.

10. The method according to claim 1 wherein the NNIFs are outputted from one or more layers of the NN.

11. The method according to claim 1 wherein the NNIFs are selected based on one or more objects of interest to be represented by the SBR representation of the NNIFs.

12. The method according to claim 1 comprising performing an autonomous driving operation based on the SBR representation of the NNIFs.

13. The method according to claim 1, wherein the SBR module comprises an encoder that is followed by a thresholding unit; wherein the training process comprises performing multiple training iterations;
wherein a training iteration comprises:
receiving by the SBR module a set of training process NNIFs;
generating, by the SBR module, a training process SBR representation;
feeding the training process SBR representation to a decoder to provide
a set of reconstructed training process NNIFs;
applying the loss function to provide a loss function value; wherein the loss function value is based on the sparsity of the training process SBR representation and on an accuracy of the set reconstructed training process NNIFs.

14. A non-transitory computer readable medium for generating a sparse binary representation (SBR) of neural network intermediate features (NNIFs) of a neural network (NN), the non-transitory computer readable medium stores instructions for:
feeding the neural network by input information;
neural network processing the input information to provide, at least, the NNIFs;
SBR processing, by a SBR module, the NNIFs, to provide the SBR representation of the NNIFs; and
outputting the SBR representation;
wherein the SBR module has undergone a training process that used a loss function that takes into account a sparsity of training process SBR representations.

15. The non-transitory computer readable medium according to claim 14, wherein the SBR module comprises an encoder that is followed by a thresholding unit.

16. The non-transitory computer readable medium according to claim 15, wherein the training process comprises performing multiple training iterations;
wherein a training iteration comprises:
receiving by the SBR module a set of training process NNIFs;
generating, by the SBR module, a training process SBR representation;
feeding the training process SBR representation to a decoder to provide
a set of reconstructed training process NNIFs;
applying the loss function to provide a loss function value; wherein the loss function value is based on the sparsity of the training process SBR representation and on an accuracy of the set reconstructed training process NNIFs.

17. The non-transitory computer readable medium according to claim 16, wherein the training process comprises evaluating an amount of irrelevant bits within the training process SBR representation.

18. The non-transitory computer readable medium according to claim 14, wherein the sparsity of the training process SBR representation is less significant than the accuracy of the set reconstructed training process NNIFs.

19. The non-transitory computer readable medium according to claim 14, wherein the NNIFs are selected based on one or more objects of interest to be represented by the SBR representation of the NNIFs.

20. The non-transitory computer readable medium according to claim 14, that stores instructions for performing an autonomous driving operation based on the SBR representation of the NNIFs.
